(19) United States
(12) Patent Application Publication
(10) Pub. No.: US 2016/0165877 A1
(43) Pub. Date: Jun. 16, 2016

(54) Wall Cap

(71) Applicant: Vincent DePaul Sosa, JR., Fountain Valley, CA (US)

(72) Inventor: Vincent DePaul Sosa, JR., Fountain Valley, CA (US)

(21) Appl. No.: 14/963,357

(22) Filed: Dec. 9, 2015

Related U.S. Application Data
(60) Provisional application No. 62/089,891, filed on Dec. 10, 2014.

(51) Int. Cl. A01M 29/30; E04D 3/40

(52) U.S. Cl. CPC A01M 29/30; E04D 3/405

(57) ABSTRACT

A wall cap that can be positioned on the upper end of a wall so as to prevent animals from climbing over the wall. The wall cap includes an elongated cover composed of a rigid material having a smooth outer surface. The elongated cover preferably includes a triangular cross sectional area so that the elongated cover forms a pointed upper end and slopes downwardly towards the front and rear sides thereof. The front and rear sides of the elongated cover each include a flange thereon, wherein the flanges can be positioned on opposing sides of the wall so as to secure the wall cap on the wall. The wall cap is secured to the wall using any suitable fastening method, such as by use of caulking or adhesives, among others.

### CROSS REFERENCE TO RELATED APPLICATION

This application claims the benefit of U.S. Provisional Application No. 62/089,891 filed on Dec. 10, 2014. The above identified patent application is herein incorporated by reference in its entirety to provide continuity of disclosure.

### BACKGROUND OF THE INVENTION

### Field of the Invention

The present invention relates to wall caps. More specifically, the present invention provides a decorative wall cap that is installed on the top of a wall to prevent rodents and other animals from climbing over the wall.

Walls composed of masonry materials, such as bricks or cinder blocks, among others, are often constructed to serve as a barrier that prevent animals and intruders from entering a property, as well as to provide privacy for the property owner. However, some animals, such as rodents, are still able to climb over the wall and enter the property, which is undesirable. The owner must then employ alternate means in addition to the wall for catching or eliminating rodents. Thus, a wall cap adapted to prevent rodents and other animals from climbing over a wall is desired.

Further, masonry walls are often industrial in appearance and lack any type of decoration or ornamentation. The walls include rows of bricks or cinder blocks stacked on top of one another in order to construct a wall of a desired height. While such walls are functional, the wall may detract from the aesthetic appeal of the property on which it is placed. Thus, a wall cap for helping to provide a decorative or ornamental appearance to the upper end of a wall is desired.

Devices have been disclosed in the prior art that relate to barriers for fences and the like. These include devices that have been patented and published in patent application publications. These devices generally relate to barriers for use with fences having points or prongs in order to keep out animals and intruders, such as U.S. Patent Application Publication Number 2007/0271859, U.S. Pat. No. 4,555,866, U.S. Patent Application Publication Number 2011/0214338, U.S. Pat. No. 8,359,791, and U.S. Patent Application Publication Number 2003/0046882.

These prior art devices have several known drawbacks. Many devices in the prior art provide barriers having spikes or prongs thereon in order to deter animals and people from passing over the barrier, however, such devices are intended to harm the animal or person and many users may find such barriers to be aesthetically unappealing. The devices in the prior art fail to provide a wall cap that can be easily secured on the top of a wall that includes a triangular cross section so as to provide a decorative appearance while also helping to prevent animals from climbing over the fence.

In light of the devices disclosed in the prior art, it is submitted that the present invention substantially diverges in design elements from the prior art and consequently it is clear that there is a need in the art for an improvement to existing wall cap devices. In this regard the instant invention substantially fulfills these needs.

### SUMMARY OF THE INVENTION

In view of the foregoing disadvantages inherent in the known types of barriers now present in the prior art, the present invention provides a new wall cap wherein the same can be utilized for providing convenience for the user when preventing animals from climbing over a wall and for providing a decorative appearance.

It is therefore an object of the present invention to provide a new and improved wall cap comprising an elongated cover having a triangular cross sectional area, and further including a pair of flanges extending along the length thereof for securing the elongated cover to the top of a wall.

It is another object of the present invention to provide a wall cap that can be affixed to the upper end of a wall via caulk or adhesives, among other types of fastening methods.

Another object of the present invention is to provide a wall cap that prevents rodents from climbing over the wall on which the wall cap is positioned.

Yet another object of the present invention is to provide a wall cap having a panel for sealing the end of the wall cap.

Another object of the present invention is to provide a wall cap that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of a first end of the wall cap.

FIG. 1B shows a perspective view of a second end of the wall cap.

FIG. 2 shows an end view of the first end of the wall cap.

FIG. 3 shows a perspective view of the wall cap as positioned on a wall.

### DETAILED DESCRIPTION OF THE INVENTION

Reference is made herein to the attached drawings. Like reference numerals are used throughout the drawings to depict like or similar elements of the wall cap. For the purposes of presenting a brief and clear description of the present invention, the preferred embodiment will be discussed as used for covering the top of a wall so as to prevent rodents and other animals from climbing over the wall. The figures are intended for representative purposes only and should not be considered to be limiting in any respect.

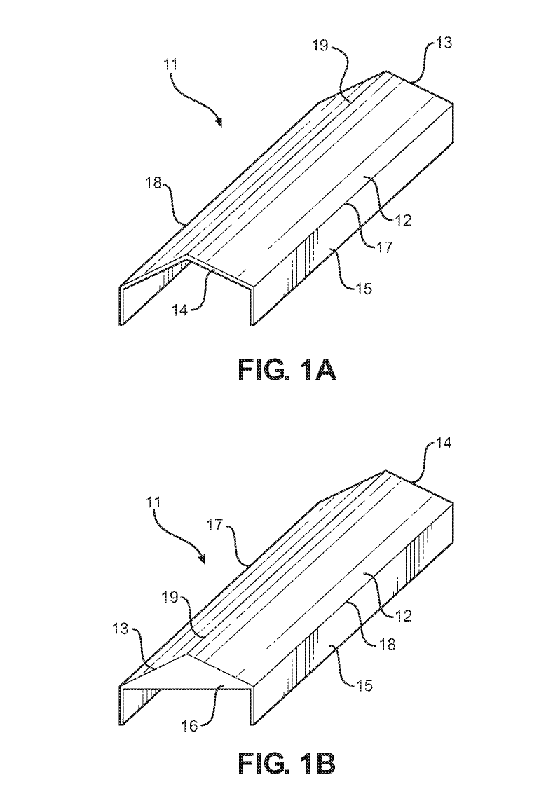

Referring now to FIGS. 1A and 1B, there are shown perspective views of the front and rear ends of the wall cap, respectively. The wall cap 11 comprises an elongated cover 12 having a length greater than its width. The elongated cover 12 includes a first end 13 opposite a second end 14, and a front side 17 opposite a rear side 18. The wall cap 11 is preferably composed of a semi-rigid or rigid material, such as polyvinyl chloride (PVC), among others. The surface of the wall cap 11 is smooth and hard so that rodents cannot dig their claws into the wall cap 11, preventing the rodents from being able to grip the wall cap 11. In this way, the smooth and hard surface of the wall cap 11 prevents rodents from being able to climb over the same.

The elongated cover 12 preferably comprises a triangular cross sectional area. Thus, the elongated cover 12 comprises a pointed upper end 19, wherein the elongated cover 12 slopes downwardly towards the front side 17 and rear side 18 thereof. The front and rear sides 17, 18 of the elongated cover 12 each comprise a downwardly extending flange 15 thereon. The flanges 15 are preferably oriented vertically and are parallel to one another. The flanges 15 are adapted to be positioned on opposing sides of a wall in order to secure the wall cap 11 on the upper end of the wall.

The first end 14 of the elongated cover 12 is substantially open and is adapted to be positioned towards a central portion of a wall. The second end 13 of the elongated cover 12 comprises a panel 16 that encloses the second end 13. The second end 13 is adapted to be positioned at the end of a wall. In this way, the elongated cover 12 at the end of a wall appears closed, which helps to prevent rodents from occupying space underneath the elongated cover 12 and helps to provide an aesthetically pleasing appearance to the wall.

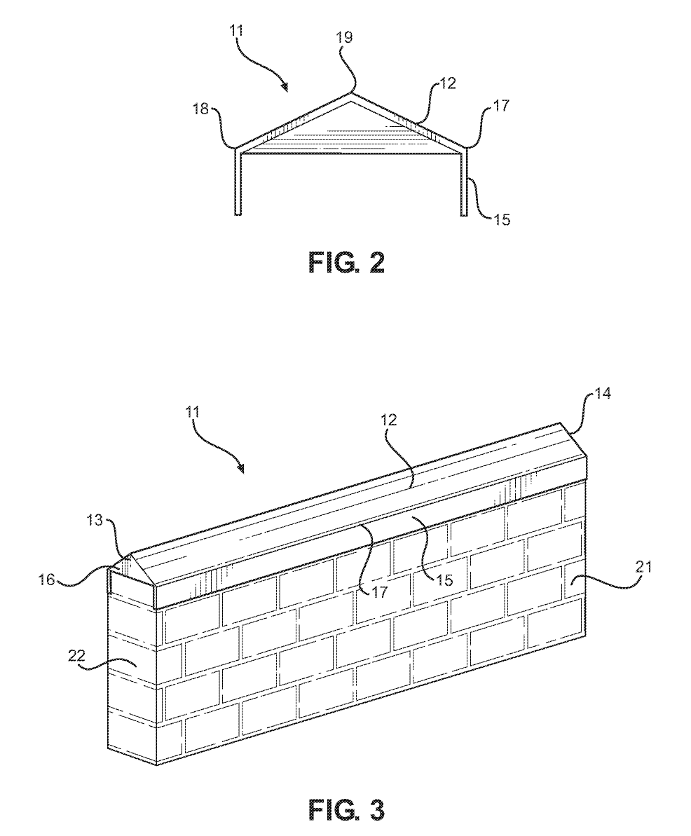

Referring now to FIG. 2, there is shown an end view of the first end of the wall cap. The elongated cover 12 comprises a substantially triangular cross section. A pointed end 19 is formed by the elongated cover 12, wherein the elongated cover 12 slopes downwardly from the pointed end 19 on opposing sides thereof. The front and rear sides 17, 18 of the elongated cover 12 each include a flange 15 thereon that extends downwardly therefrom. The elongated cover 12 and flanges 15 define a hollow interior volume.

Referring now to FIG. 3, there is shown a perspective view of the wall cap as positioned on a wall. In operation, the wall cap 11 is adapted to be installed on the upper end of a wall 21, wherein the wall 21 is preferably composed of masonry material, such as brick or cinder blocks, among other similar materials. The wall cap 11 preferably extends the length of the wall 21 and comprises substantially the same width as the wall 21 on which it is positioned. The flanges 15 on the front side 17 and rear side of the elongated cover 12 are positioned on the front and rear sides of the wall 21 respectively so as to secure the wall cap 11 on the upper end of the wall 21. The elongated cover 12 can be secured in place using any suitable fastening method, such as by means of caulk or adhesives, among others. The wall cover 11 is positioned such that the second end 13 thereof having the panel 16 is positioned on the end 22 of the wall 21, so that the space underneath the elongated cover 12 is not accessible. Further, the panel 16 on the second end 13 of the elongated cover 12 provides a smooth or continuous surface along the end 22 of the wall 21.

Thus, the wall cap 11 provides a decorative appearance to the upper end of the wall 21. Further, the wall cap 11 helps to prevent animals, such as rodents, from climbing over the wall 21. The wall cap 11 is composed of a hard material with a smooth surface so that rodents cannot easily grasp the wall cap 11 in order to climb over the same. Further, the slope of the wall cap 11 further helps to prevent rodents from climbing over the wall 21.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will 0readily occur to those skilled in the art, it is not desired to limit the invention to the exact construction and operation shown and described, and accordingly, all suitable modifications and equivalents may be resorted to, falling within the scope of the invention.

I claim:

1) A wall cap, comprising:
an elongated cover having a first end opposite a second end, and a front side opposite a rear side, wherein said elongated cover is adapted to be disposed on an upper end of a wall;
wherein a flange extends downwardly from said front side and said rear side of said elongated cover, said flanges adapted to be positioned along a front portion and a rear portion of said wall, respectively.

2) The wall cap of claim 1, wherein said elongated cover comprises a triangular cross sectional area.

3) The wall cap of claim 1, wherein said elongated cover comprises a pointed upper end such that said elongated cover slopes downwardly from said pointed upper end towards said front side and said rear side thereof.

4) The wall cap of claim 1, wherein said elongated cover is composed of a rigid material.

5) The wall cap of claim 1, wherein said elongated cover comprises a panel on said second end so as to enclose said second end of said elongated cover.

6) The wall cap of claim 1, wherein said elongated cover comprises a smooth surface.
